(19) United States
(12) Patent Application Publication
(10) Pub. No.: US 2006/0143152 A1
(43) Pub. Date: Jun. 29, 2006

(54) Vender code generation method

(76) Inventor: Tien-Chieh Wu, Taipei City (TW)

Correspondence Address: RABIN & BERDO, P.C., Suite 500, 1101 14th Street, N.W., Washington, DC, 20005, US

(21) Appl. No.: 11/315,336

(22) Filed: Dec. 23, 2005

(30) Foreign Application Priority Data
Dec. 27, 2004 (TW) 93140760

(51) Int. Cl. G06F 17/30; G06F 7/00

(52) U.S. Cl. 707/1

(57) ABSTRACT

A vender code generation method is used to allow venders of the same business conglomerate to have only one vender code without duplication. The enterprise is able to obtain the application data of the vender through the Internet by using an application form. Upon verifying that the identification data in the application form is different from the verification data in the database, that is, verifying that no other venders in the same business conglomerate have already obtained the vender code, then the method is used to automatically generate and issue the vender code to the vender, so as to minimize the manual operation required and to avoid the duplication of vender codes.

### CROSS-REFERENCE TO RELATED APPLICATIONS

This non-provisional application claims priority under 35 U.S.C. § 119(a) on Patent Application No(s). 93140760 filed in Taiwan, R.O.C. on Dec. 27, 2004, the entire contents of which are hereby incorporated by reference.

### BACKGROUND OF THE INVENTION

1. Field of the Invention

The invention relates to a vender code generation method, and in particular to a vender code generation method that is capable of automatically implementing the examination of the vender's application data and the generation of the vender code.

2. Related Art

Due to the rapid progress and development of information sciences and technology, the ever expanding scope of enterprises and their business operations are becoming more complicated. Therefore, the close cooperation of enterprises with venders and the integration and utilization of information to improve competitiveness and satisfy customers' demands, are the most essential measures to maintain enterprises' successful operations.

Among the above-mentioned measures, the coordinated procurement operation is the first and most important step in strengthening the core competitiveness of the enterprise. Only when the enterprise is able to obtain materials required in a timely fashion and at reasonable prices can the enterprise possess the most favorable competitive conditions. Therefore, the efficient control and management of the vender supplying the materials is essential to sharpening the competitive edge of the enterprise. Adding better venders to replace incompetent venders is an effective way to obtain better service from the venders.

The generation of the vender code is the first step for including venders in the above-mentioned coordinated procurement operation. Most enterprises make use of the serial number of the vender code to verify and ascertain the attributes and specialties of their venders.

For more detailed description, please refer to FIG. 1, which shows the flowchart illustrating the vender code generation method of the prior art, comprising the following steps:

Firstly, getting in touch with the vender and asking it to provide the necessary application data (step 100); then, manually recording the application data (step 110); and executing the examination procedure; most examination procedures of the prior art made use of the vender's business registration unified number to verify if the vender's application would result in the existence of more than one vender code for a single vender.

Subsequently, manually compiling and recording the vender code: upon verifying that the vender has not applied for more than one vender code, manually compiling the vender code according to the predetermined coding procedure (step 120); and finally, issuing the vender code examination results manually; the procurement staff tells the vender its vender code (step 130).

In the above-mentioned procedure, a lot of time is wasted, or it may result in many errors. For example, when contacting the vender via telephone or post service system, if the vender is not able to respond in time, the effort of repeated contact could waste time. In addition, the staff of the enterprise may be unfamiliar with the application data provided by the vender, which may cause errors. Furthermore, at present, most of the vender code applications are handled through paperwork, which causes difficulty in storage and waste of paper.

Many venders belong to both the subsidiary and the parent company of the same business conglomerate, yet they each may apply for more than one vender code, thus leading to the result that the enterprise concerned is not able to have effective control of the actual supply conditions of the materials. For example, the parent company and subsidiary are in the same situation regarding the deficiency of the same material, and as such they cannot get that material replaced when the supply of that material is running short.

In addition, the fact that the same individual vender belongs to the subsidiary and parent company of the same business conglomerate could weaken competition among venders. For example, a large number of individual venders in the same business conglomerate may use their vender codes to achieve the purpose of illegal bidding.

Therefore, it is the common desire of the various enterprises to reduce human error, while obtaining the most accurate data about their venders.

### SUMMARY OF THE INVENTION

The object of the invention is to provide a vender code generation method to overcome and shortcomings and limitations of the prior art. The method is to enable the enterprise to carry out the application, examination, and issue of the vender code through a network with the venders. Whether the application vender and the existing vender in the enterprise file belong to the same business conglomerate is a prerequisite for passing the examination. The method according to the embodiment of the invention includes the following steps: Firstly, receiving the application instructions output from the vender; then, opening the application form according to the instructions for the vender to complete; next, receiving the application data completed by the vender containing at least the identification data; subsequently, retrieving the identification data contained in the application form; then, comparing the identification data with the verification data contained in the data base; and finally, upon verifying that the identification data and the verification data are different, issuing the vender code to the vender.

Further scope of the applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a flowchart illustrating the vender code generation method according to the prior art;

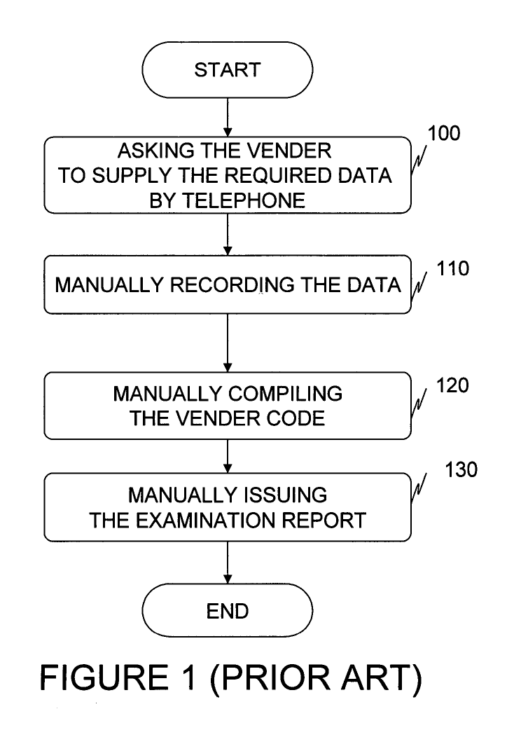

FIG. 2 is a schematic diagram illustrating the equipment required for the operation of the vender code generation method according to the embodiment of the invention;

FIG. 3 is a schematic diagram for the interface of the application form used in the embodiment of the invention;

FIG. 4 is a schematic diagram for the contents of the verification data used in the embodiment of the invention; and

FIG. 5 is a flowchart for the vender code generation method according to the embodiment of the invention.

### DETAILED DESCRIPTION OF THE INVENTION

The purpose, construction, features, and functions of the invention can be appreciated and understood further through the following detailed description with reference to the attached drawings.

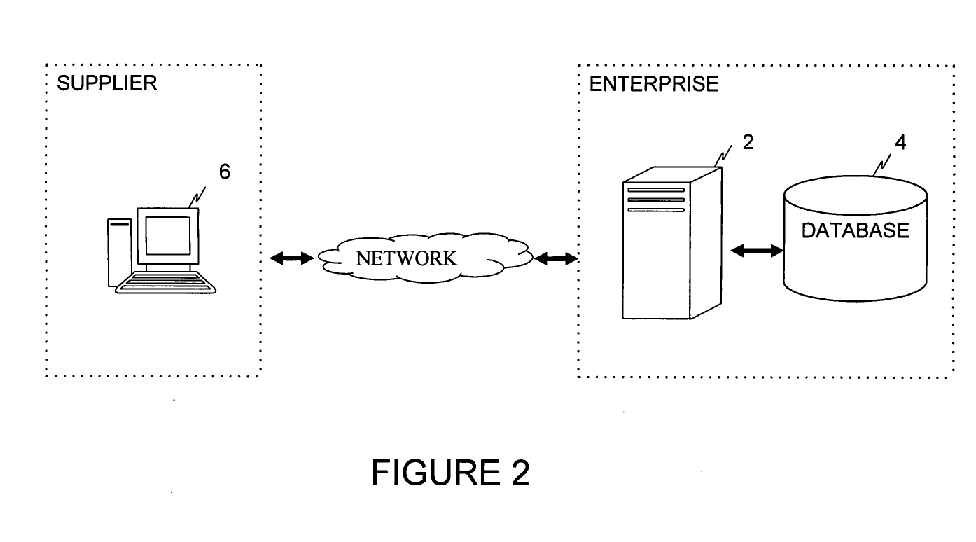

FIG. 2 is a schematic diagram illustrating the equipment required for the operation of the vender code generation method according to the embodiment of the invention, comprising an application server 2, a database 4, and a vender's computer 6, which will be described in detail as follows:

Firstly, the application server 2 is disposed at the enterprise for providing the application forms and is also used as the vender code generation system. The application form is used to receive the completed data through the network and update the web-based system, such as the web-based FTP, etc.

Next, the database 4 is used to provide the verification data. The database 4 is capable of operating on the application server 2 or can be a stand-alone database server connected to the application server 2 through the network. The database 4 can also be a Relational Database Management System (RDBMS) having security control and management functions, for example, Structured Query Language (SQL) Database, Oracle Database, Informix, DB2, Sybase, ODBC, EDA, SAP, PepleSoft, JDEwards, MQSeries, CICS, or other DBMS Databases.

Furthermore, the vender computer 6 is provided at the vender site and is used to execute the browser programs (for example, Microsoft Internet Explorer or Netscape Navigator) or the characterized on-line programs (for example, Telnet-based program). It is connected to the application server 2 through the network, and is used to generate the application instructions by making use of the input device to enable the application server 2 to provide the application form so as to generate the application data.

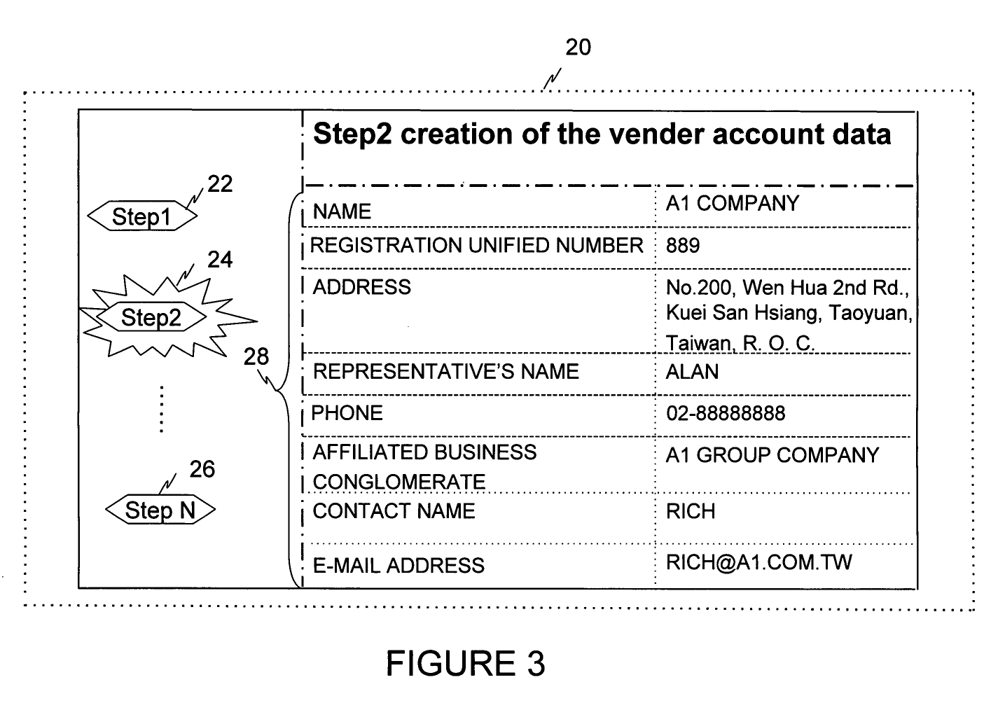

FIG. 3 is a schematic diagram for the interface of the application form used in the embodiment of the invention. As shown in FIG. 3, the application form 20 is provided with a plurality of indicators 22, 24, and 26, and a plurality of application data columns 28, wherein the indicators 22, 24, and 26 can be used to generate different colors and indicate the filling-in conditions of the application data.

In the above description, the application data column 28 is used by the enterprise to remind the vender to provide the application data. As such, the vender is able to provide the application data required by the enterprise according to the instructions given by the indicator 22, 24, or 26 in the application form. Furthermore, the application data should at least include: the vender's business operation registration certificate, the vender's name, the vender's business registration unified number, the vender's address, the vender representative's name, the vender's contact phone number, the vender's affiliated business conglomerate, the vender contact's name, and the vender contact's e-mail address, etc. The vender's name, the vender business registration unified number, the vender's address, the vender representative's name, the vender's contact phone number, the vender's affiliated business conglomerate, the vender contact's name, and the vender contact's e-mail address may be used as identification data.

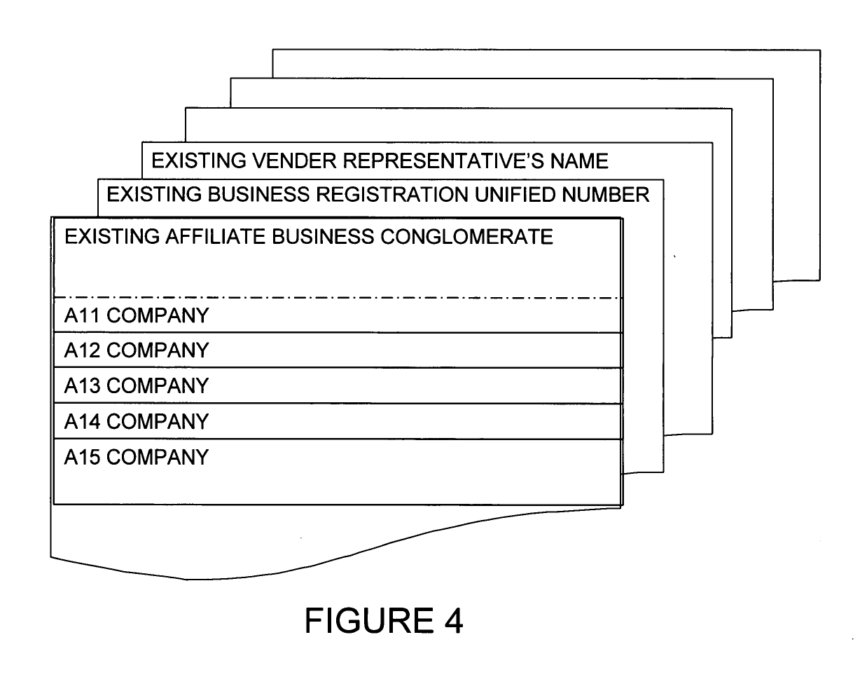

FIG. 4 is the schematic diagram of the contents of the verification data, which is stored in the data base 4, and includes: the existing vender's name, the existing vender's business registration unified number, the existing vender's address, the existing vender representative's name, the existing vender's contact phone number, the existing vender's affiliated business conglomerate, the existing vender contact's name, and the existing vender contact's e-mail address, etc. The existing vender is the vender that already has a vender code.

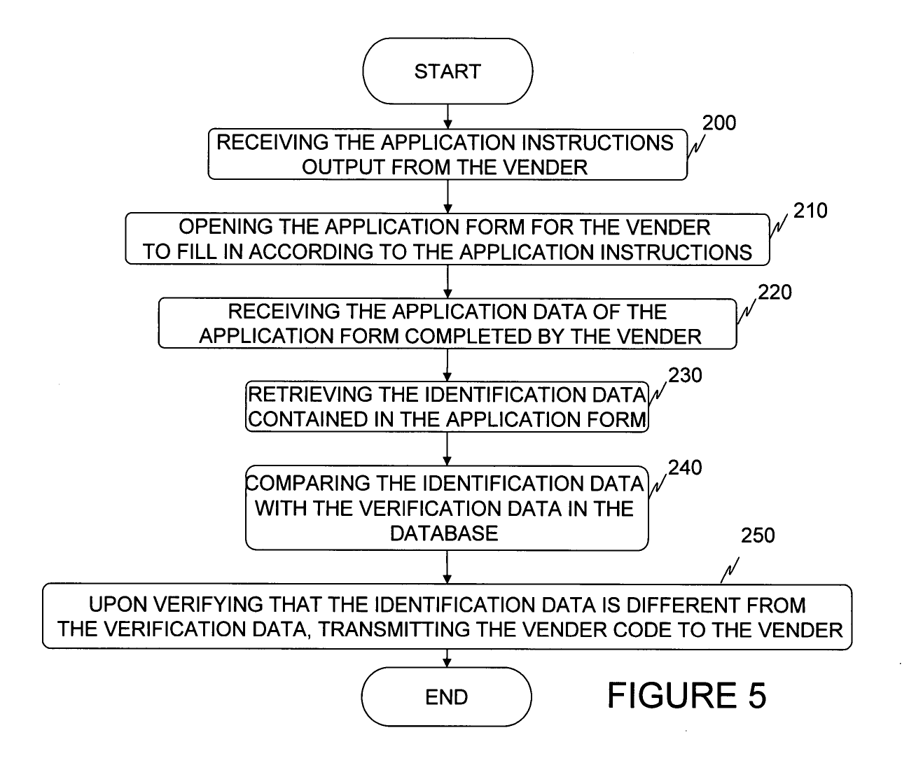

FIG. 5 is the flowchart for the vender code generation method according to the embodiment of the invention. As shown in FIG. 5, it comprises the following steps:

Receiving the application instructions sent by the vender (step 200); opening the application form for the vender to fill in data according to the application instructions, which are generated through the input device after the vender is connected to the application server 2 via the browser program or the characterized on-line program (step 210); upon receiving the application instruction, the application server 2 executes and opens the application form.

Then, receiving the application data of the application form filled in by the vender comprising identification data (step 220); the vender completes in sequence the procedures of filling in the application data in the application data column 28 according to the instructions given by the indicator 22, 24 or 26 of the application form; next, retrieving the identification data contained in the application form (step 230); then, comparing the identification data with the verification data stored in the database (step 240); the predetermined retrieval object of the enterprise is utilized by the application server 2 as the basis for retrieving the identification data and the verification data. For example, if the retrieval object set by the enterprise is “the affiliated business conglomerate,” then the data of the vender's affiliated business conglomerate in the application form is retrieved as the identification data, while the data of the existing vender's affiliated business conglomerate in the database 4 is retrieved as the verification data.

Finally, generating and transmitting a vender code to the vender, upon verifying that the identification data is different from the verification data (step 250); that is, if the identification data is different from the verification data, then the vender code is generated by the application server 2 and transmitted to the vender's computer 6 via e-mail or a signed digitalized document. On the other hand, if the result of the identification data is the same as the verification date, then an examination report is generated by the application server 2 and transmitted to the vender via e-mail or signed digitalized document, thus informing the vender that the vender code already exists.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A vender code generation method, which is used to enable the enterprise to generate and issue a vender code to the vender via the network, comprising the following steps:
receiving the application instruction from said vender;
opening an application form for the vender to fill in according to said application instruction;
receiving the application data filled in the application form by said vender containing at least an identification data;
fetching said identification data from said application form;
comparing said identification data with the verification data contained in the data base; and
verifying and making sure that said identification data is different from said verification data, then transmitting the vender code to said vender.

2. The vender code generation method as claimed in claim 1, wherein said application form is provided with a plurality of indicators to guide said vender to fill in said application data.

3. The vender code generation method as claimed in claim 2, wherein said indicators are used to indicate the filling-in conditions of said application data.

4. The vender code generation method as claimed in claim 2, wherein a plurality of color variations are utilized by said indicators to indicate the filling-in conditions of said application data.

5. The vender code generation method as claimed in claim 1, wherein said identification data is selected from one of following items comprising the group of:
the vender's name, the vender's business registration unified number, the vender's address, the vender representative's name, the vender's contact phone number, the vender's affiliated business conglomerate, the vender contact's name, and the vender contact's e-mail address.

6. The vender code generation method as claimed in claim 1, wherein said verification data is selected from one of following items comprising the group of:
the existing vender's name, the existing vender's business registration unified number, the existing vender's address, the existing vender representative's name, the existing vender's contact phone number, the existing vender's affiliated business conglomerate, the existing vender contact's name, and the existing vender contact's e-mail address.

7. The vender code generation method as claimed in claim 1, wherein said data base is a relational database management system (RDBMS).

8. The vender code generation method as claimed in claim 7, wherein said relational database management system (RDBMS) is selected from one of the following comprising the group of: structured query language (SQL) database, Oracle database, Informix, DB2, Sybase, ODBC, EDA, SAP, PeopleSoft, JDEdwards, MQSeries and CICS.

9. The vender code generation method as claimed in claim 1, wherein generating and transmitting an examination report to said vender, if said identification data is the same as said verification data.

10. The vender code generation method as claimed in claim 7, wherein said examination report is transmitted to said vender through an e-mail/signed digitalized document.

11. The vender code generation method as claimed in claim 1, wherein said vender code is transmitted to said vender through an e-mail/signed digitalized document.
